(19) United States
(12) Patent Application Publication
(10) Pub. No.: US 2026/0277677 A1
(43) Pub. Date: Sep. 17, 2026

(54) INDEPENDENT CONFIGURATION ADJUSTMENT FOR NETWORK INFRASTRUCTURE MANAGEMENT

(71) Applicant: Capital One Services, LLC, McLean, VA (US)

(72) Inventors: Brent SEGNER, Marysville, OH (US); Jerzy Jan GRZYWINSKI, Midlothian, VA (US); Michael BRAGALONE, Jersey City, NJ (US)

(73) Assignee: Capital One Services, LLC, McLean, VA (US)

(21) Appl. No.: 19/078,261

(22) Filed: Mar. 12, 2025

(51) Int. Cl. G06F 9/50

(52) U.S. Cl. CPC G06F 9/5016; G06F 2209/5022

(57) ABSTRACT

A method for managing real network infrastructure. The method includes adjusting a configuration parameter for the application to a new value using a machine learning model based on the application-related values obtained during that period. It also involves predicting a new value and determining whether the resource-related metric for the second period meets a set of criteria based on the new value.

### SUMMARY

Cloud system management often involves accounting for infrastructure complexity. A cloud system involves diverse components within a cloud environment, where each component may present unique dependencies, potential failure modes, and recovery mechanisms. During operations, resource failures can emerge from complex system interactions and unexpected runtime operations. Such resource failures may be fatal to the proper operation of one or more applications or services reliant on the cloud system. Moreover, such failures become more likely in real-world scenarios, where both predicted and unexpected surges in users, resource-heavy application utilization, or memory demands may cause cascading failures.

Orchestration may provide a means of coordinating and managing multiple services, applications, or processes to execute complex workflows. When failures occur, orchestration operations may implement features like automatic retries, fallback mechanisms, circuit breakers, etc. Orchestration may centralize management tasks and reduce the complexity of handling failures in individual services and increase the likelihood that a system remains reliable and resilient even when individual components experience issues. However, implementing effective orchestration presents its own challenges, including increased system complexity, potential performance overhead from coordination activities, and a lack of transparency into the effects of orchestration operations when not made in the context of a catastrophic failure.

Some embodiments may resolve such issues and other issues by overseeing network infrastructure using a model that learns by modifying resource availability for an adaptively scaled application and then comparing the results with one or more predicted outcomes. Some embodiments may determine that a resource-related metric for an application is within a utilization tolerance representing acceptable operations during a first period. During the first period, some embodiments may then adjust a configuration parameter for the application to an adjusted value using a machine learning model based on the first application-related values obtained during that period. Some embodiments may determine a predicted value for a second period based on second application runtime telemetry values obtained during the second period. For example, some embodiments may collect CPU usage values and memory consumption values and use these collected values to predict a future processor utilization percentage for the second period. Some embodiments may determine a result indicating that the resource-related metric for the second period satisfies a set of improvement criteria based on the predicted value, such as an improvement criteria that a processor utilization percentage be at least 10% closer to a Goldilocks value than a predicted processor utilization value. Some embodiments may modify a resource schedule associated with the application to include the adjusted value at a future time based on the first application-related values.

By performing operations and using related devices described in this disclosure, some embodiments may improve application resilience and reliability while managing real network infrastructure. By aligning computational resources with application needs in real-time, some embodiments may improve system performance and scalability. Such an approach supports consistent application performance, facilitates easy adaptation to changing workloads, and enhances overall system reliability.

Various other aspects, features, and advantages of the invention will be apparent through the detailed description of the invention and the drawings attached hereto. It is also to be understood that both the foregoing general description and the following detailed description are examples and are not restrictive of the scope of the invention.

### BRIEF DESCRIPTION OF THE DRAWINGS

FIG. 1 shows an example system for managing network infrastructure for an application by comparing post-modification measurements with predicted results, in accordance with one or more embodiments.

FIG. 2 shows an example conceptual architecture for managing network infrastructure for an application, in accordance with one or more embodiments.

FIG. 3 shows a flowchart of a process for training and using a machine learning model to manage network infrastructure for an application based on predicted results, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

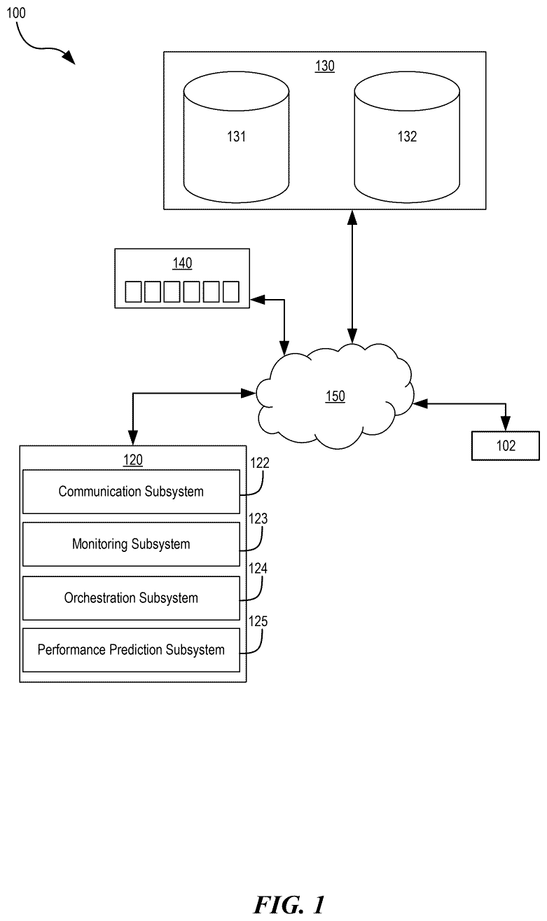

FIG. 1 shows an example system 100 for managing network infrastructure for an application by comparing post-modification measurements with predicted results, in accordance with one or more embodiments. A system 100 includes a client device 102 in communication with a server 120 via a network 150. As will be described further in this disclosure, the client device 102 may perform operations to quickly retrieve data from an in-memory system (e.g., retrieval in less than 1 second, less than 10 milliseconds, 1 millisecond, less than 800 microseconds, less than 600 microseconds, etc.).

In some embodiments, the system 100 may increase the reliability and efficiency of an application by using a machine learning model to control the distribution of computational resources like CPU, memory, and storage. Some embodiments may determine that a resource usage metric for an application is within a utilization tolerance during a first period and adjust a configuration parameter for the application during this first period. The application may be dynamically scaled as a result of predicted or unpredicted changes in application use. By adjusting values during this first period, some embodiments may explore a parameter space in a real-world scenario during an adjustment period most likely to tolerate changes without impacting noticeable application performance. During a second period, some embodiments may predict a utilization value, determine that the resource usage metric satisfies a set of improvement criteria based on the predicted utilization value, and modify a resource schedule associated with the application.

During an adjustment period, some embodiments may use a machine learning model, such as a reinforcement learning model, to determine a value based on first application runtime telemetry values for a configuration parameter. This configuration parameter may be used to control infrastructure for a deployed application executed by one or more nodes. By using a machine learning model, some embodiments may be more capable of providing nonlinear responses and learn from real-world responses to infrastructure adjustments. Some embodiments may, during a second period, forecast a utilization value, ascertain that the resource usage metric meets a set of improvement criteria based on the predicted utilization value, and adjust a resource schedule associated with the application.

Some embodiments may determine that a resource usage metric for an application is within a utilization tolerance during an adjustment period and adjust a configuration parameter to an adjusted value using a machine learning model based on telemetry values. Some embodiments may predict a utilization value for an evaluation period based on new telemetry values obtained during that evaluation period and determine that the resource usage metric for the evaluation period satisfies a threshold or other criterion based on the predicted utilization value. By using a predicted value and then comparing an outcome metric with the predicted value, some embodiments may train a machine learning model with real-time data and account for real-world issues that may cause improvements or degradation in application performance independently of any effects caused by adjustments. Moreover, using prediction model values generated during an adjustment period instead of an evaluation period may help train a model to provide explainable predictions that are better suited for real-time operations. Some embodiments may then update a schedule for a distributed system based on the change.

Some embodiments may determine that a resource usage metric for an application is within an acceptable range during a first period and tweak a configuration parameter for the application to a new value using a machine learning model based on telemetry data from that period. Additionally, some embodiments may predict a utilization value for a second period using telemetry data from that second period and determine that the resource usage metric for the second period meets certain improvement criteria based on the predicted value. Based on the result, some embodiments may update a machine learning model to favor making such an adjustment or modify a resource schedule associated with the application to include the adjusted value at a future time based on the first application runtime telemetry values. By adjusting a schedule for a distributed application, some embodiments may implement a response system capable of adjusting for future possible overloads or underloads.

The client device 102 may include one of various types of computer devices usable as a client-side device, such as a laptop, data terminal, mobile computing device, etc. The client device 102 may send requests, responses, or other messages to the server 120 that may require communication with other computing devices or other electronic devices. Additionally, the server 120 may include various types of computing units, such as physically separate servers, virtual nodes hosted on one or more physical machines, or nodes on a cloud computing system. Applications, services, or other operations may use data provided by the client device 102, the server 120, a distributed cache system 140, or a set of databases 130 that includes a first networked database 131 and a second networked database 132. The set of databases 130 may include various types of databases, such as SQL databases, no SQL databases, graph databases, etc. In some embodiments, the server 120 may perform one or more operations related to a communication subsystem 122, a monitoring subsystem 123, an orchestration subsystem 124, or a performance prediction subsystem 125.

In some embodiments, the communication subsystem 122 may obtain program instructions, commands, parameters, values, or other data from the client device 102, the set of databases 130, or the distributed cache system 140. For example, the communication subsystem 122 may retrieve a set of parameters from the set of databases 130. Furthermore, operations performed by the server 120 may use the communication subsystem 122 to send messages to the set of databases 130, the client device 102, the distributed cache system 140, or another computing device described in this disclosure. Furthermore, some embodiments may use the communication subsystem 122 to communicate with one or more remote computing devices to offload some or all of the operations described in this disclosure. For example, some embodiments may use the communication subsystem 122 to provide a remote computing system with data retrieved from the distributed cache system 140 to determine a sum, product, or other aggregated value. The communication subsystem 122 may then provide the aggregated value to a machine learning model to obtain a model result.

In some embodiments, the monitoring subsystem 123 may track the health, performance, and resource utilization of various components of a cloud computing system. For example, the monitoring subsystem 123 may track the status and utilization of containers, virtual machines, networks, databases, and application services. The system collects metrics such as central processing unit (CPU) usage, memory consumption, disk I/O, network latency, request throughput, and error rates from each component. For example, the monitoring subsystem 123 may monitor a web application deployed across multiple regions and pull data from load balancers, application servers, and databases every few seconds.

In some embodiments, the monitoring subsystem 123 may also serve to provide alert operations. For example, if a CPU utilization metric or a memory usage metric for an application server exceeds 80% for more than five minutes, the monitoring subsystem 123 may trigger an alert and initiate auto-scaling to launch additional server instances. The monitoring subsystem 123 may also record this incident, track the resolution time, and store historical performance data to help teams identify patterns and optimize resource allocation over time.

In some embodiments, the orchestration subsystem 124 may dynamically scale or otherwise manage resource allocation. For example, the orchestration subsystem 124 can adjust memory allocation, processor allocation, and other resources based on real-time application needs and predicted outcomes. By leveraging machine learning models, the orchestration subsystem 124 can modify resource availability for applications, ensuring that resource-related metrics remain within acceptable utilization tolerances.

In some embodiments, the orchestration subsystem 124 may adjust operations of a cloud system during an adjustment period that occurs while operations are already operating within a tolerance boundary. For example, during an adjustment period in which an application's memory utilization and processor utilization are within accepted boundaries, an orchestration subsystem 124 may adjust a memory configuration parameter to allocate additional resources to a deployed application. The orchestration subsystem 124 may perform this adjustment by providing a reinforcement learning model with state variables that indicate infrastructure state and application runtime telemetry values during the adjustment period. For example, a reinforcement learning model of the orchestration subsystem 124 might use data on CPU usage and memory consumption to determine a memory allocation for the application based on a reinforcement model policy that explores new configuration state parameters.

In some embodiments, the performance prediction subsystem 125 may determine (e.g., via the monitoring subsystem 123) a predicted memory utilization value associated with the deployed application for the evaluation period based on second application runtime telemetry values obtained during the evaluation period. For example, the performance prediction subsystem 125 may analyze data on memory consumption and CPU usage collected during the evaluation period to predict the memory utilization for the deployed application in the evaluation period. The performance prediction subsystem 125 may predict various types of predictions, including predictions for a system state if no adjustments were made and a system state if the adjustments are made. For example, the performance prediction subsystem 125 may predict that, if no adjustments are made, the system state will experience high memory utilization, leading to potential slowdowns or crashes. For example, the performance prediction subsystem 125 may predict that a memory usage will exceed 90% using a performance prediction model based on the feedback data provided on one or more infrastructure components based on data. Furthermore, the performance prediction subsystem 125 may predict that if adjustments are made, such as increasing memory allocation, the system state memory utilization will be at 70%.

As described elsewhere in this disclosure, some embodiments may obtain a predicted performance value (e.g., via a performance prediction subsystem 125). The orchestration subsystem 124 may use this prediction to determine an improvement threshold or other set of criteria based on a predicted memory utilization value, such as a predicted memory utilization value. For example, the orchestration subsystem 124 may set a maximum memory utilization threshold to be 1% less than a predicted memory utilization value and compare an actual memory utilization value with the maximum memory utilization threshold. A performance metric that satisfies a maximum threshold or minimum threshold may indicate that an adjustment made during an adjustment period was an improvement, whereas a performance metric that does not satisfy the maximum or minimum threshold may indicate that the adjustment did not make sufficient improvements or even provided no improvement at all.

By determining whether an adjustment was an improvement based on a predicted value instead of a comparison with a past performance metric, some embodiments may account for uncontrolled changes in resource use. For example, without using a predicted utilization value and instead using a past memory utilization value, some embodiments may detect that an increase in memory allocation has actually resulted in an increase in utilization and punish memory allocations via a policy of a reinforcement learning model. By using one or more prediction-based thresholds or other prediction-based criteria (e.g., a range, a cost function, etc.) for comparing with an infrastructure state, some embodiments may account for the effect that both predicted and unpredicted real-time changes in application utilization may have on the infrastructure state.

The performance prediction subsystem 125 may use various types of prediction models. For example, the performance prediction subsystem 125 may use resource utilization, Autoregressive Integrated Moving Average (ARIMA) models and Long Short-Term Memory (LSM) networks to predict future resource needs based on historical time-stamped data of processor loads, memory consumption patterns, network traffic volumes, memory storage usage, etc. As another example, the performance prediction subsystem 125 may use Isolation Forests and Support Vector Machines (SVM) to analyze system metrics, error logs, response times, and network latency patterns to identify unusual system behavior, while capacity planning ingests data about user growth rates, application deployment schedules, and seasonal business patterns to forecast resource needs.

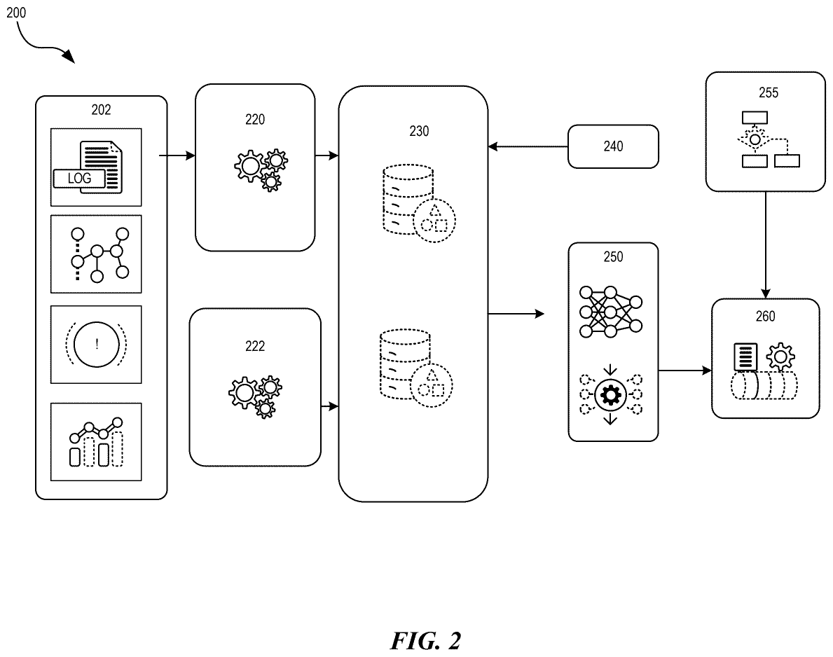

FIG. 2 shows an example conceptual architecture 200 for managing network infrastructure for an application, in accordance with one or more embodiments. As shown in the conceptual architecture 200, some embodiments may collect system performance data 202. The system performance data 202 may include data from a range of diagnostic tools that help monitor, analyze, and optimize system behavior. This list includes streaming telemetry that provides continuous monitoring by collecting real-time data on system metrics such as CPU usage, memory consumption, network activity, and response times. Some embodiments may send the system performance data 202 to feature store 230 for storage and analysis. This real-time flow of information helps identify potential bottlenecks or issues before they escalate, ensuring a stable and efficient system operation.

The system performance data 202 may include traces and event logging complement telemetry. Traces may capture a sequence of events or processes that occur within a system that enable analysis subsystems to follow the flow of execution across distributed services and identify where delays or failures happen. Event logging records and system events, such as errors, warnings, or essential state changes, may provide a historical record that can be used for troubleshooting and auditing.

In some embodiments, an Extract-Transform-Load (ETL) service 220 may ingest performance data from the system performance data 202 or other data sources and perform ETL functions to convert the raw, continuous data into a format that is suitable for analysis. During the ingestion phase, ETL service 220 may capture real-time performance data from various sources, including telemetry, traces, and event logs. Once ingested, the data may be temporarily stored in a staging area where the extraction process begins, pulling relevant information from the raw data, such as system metrics, timestamps, and event identifiers. After extraction, the transformation phase may clean and standardize the data to ensure consistency and compatibility with downstream tools. Finally, once the transformation is complete, the data may be loaded into a centralized feature store, making it ready for querying and analysis.

In addition to real-time data provided via the ETL service 220, some embodiments may ingest batch data via a batch data ingestion service 222. The batch data ingestion service 222 may pull additional context data, such as context data related to criticality, resilience, and Service Level Objective (SLO) requirements. The batch data ingestion service 222 may periodically collect structured metadata from various sources, such as configuration management databases (CMDBs), continuity planning systems, and service level object (SLO) monitoring platforms. The batch data ingestion service 222 may extract relevant information about system or application criticality, resilience requirements, and SLO thresholds. During a transformation phase, the batch data ingestion service 222 may align the data with existing system metrics to generate enriched data that includes context. The batch data ingestion service 222 may then load the enriched data into a feature store 230.

Some embodiments may then store the system performance data 202 or other data provided by the ETL service 220 or the batch data ingestion service 222 in the feature store 230. The feature store 230 may include a centralized repository for curated data features that may be used to support model training and inference functions. During a model training phase, the feature store 230 may supply historical data features. For inference, the feature store 230 may provide real-time or batch features applied to incoming data, increasing the likelihood that the features used during inference would match those used during training.

Some embodiments may employ a set of diagnostic machine learning models 240 to generate classifications for infrastructure states or application states and detect anomalies in the performance data. For example, the model might identify unusual patterns in CPU usage or memory consumption that indicate potential issues. The output from the set of diagnostic machine learning models 240 can be used to provide additional inputs used to adjust a response.

Some embodiments may use a set of machine learning models 250 to infer adjustments to an infrastructure system based on data in the feature store 230.

The set of machine learning models 250 may perform operations such as generating or combining time series forecasting algorithms and neural networks for system performance prediction, classification, and anomaly detection. A set of machine learning models 250 may collect continuous performance data, such as CPU usage, memory consumption, and network throughput. A set of machine learning models 250 may implement one or more time series forecasting models (e.g., ARIMA, Prophet, or Long Short-Term Memory (LSTM)) to this historical data to predict future trends and identify potential changes in system behavior. By collecting a meaningful period of data, the set of machine learning models 250 may detect patterns over time, enabling the forecasting model to anticipate performance fluctuations, such as spikes in resource usage or drops in service availability.

Additionally, the set of machine learning models 250 may include neural networks for workload classification and anomaly detection. Some embodiments may train a neural network on labeled performance data, where different types of workloads (e.g., normal operations, batch jobs, or high-demand periods) are classified based on unique patterns. Additionally, some embodiments may train a neural network to recognize abnormal behaviors or anomalies that deviate from historical norms. In some embodiments, a trained neural network can classify workloads and detect outliers in real time, distinguishing between expected workload variations and true performance anomalies. The combination of time series forecasting and neural-network-based classification and detection systems may provide an improved approach to maintaining system stability, predicting performance shifts, and quickly responding to unexpected issues. It should be understood that other types of machine learning models may be used in addition to or in lieu of neural networks. Such models may include unsupervised models (e.g., K-means clustering models or other clustering models), semi-supervised models, and super-vised models. For example, a computer system may use K-means clustering with feature weighting to create a set of initial clusters to identify specific known conditions associated with abnormal behaviors or anomalies. The computer system may then use a combination of a random forest classifier component and multiple output classifier component as part of the set of machine learning models 250.

Some embodiments may provide data from the feature store 230 or other data to a rules engine 255 to determine one or more outputs to provide to the orchestration system 260. The rules engine 255 may apply security, resilience, cost controls, or other boundaries to operations before permitting the orchestration system 260 to provision new infrastructure or make changes to existing infrastructure. In some embodiments, the rules engine 255 may operate as an automated decision-making system, using predefined business rules, security policies, and best practices as filters to evaluate infrastructure requests. When a new resource is requested, or an existing one is modified, the rules engine 255 may check for compliance with security standards, such as encryption requirements, access control policies, and network configurations. If the request violates any security rules, the rules engine 255 may flag or automatically reject the request until adjustments are made to meet security criteria.

Additionally, the rules engine 255 may assess resilience-related policies, ensuring that the infrastructure meets requirements for redundancy, disaster recovery, and failover capabilities based on the system's criticality. For example, high-availability systems may be required to run across multiple availability zones or data centers, while less critical systems might have lower resilience requirements. Finally, the rules engine 255 may enforce cost controls by evaluating whether the requested infrastructure complies with budget constraints and cost-optimization strategies, such as applying lifecycle policies or ensuring that retention periods are set on logging.

Some embodiments may then use an orchestration system 260 to adjust a cloud infrastructure based on one or more outputs of the set of machine learning models 250. For example, if the set of machine learning models 250 predict that an application will experience high memory usage during peak hours, the orchestration system 260 may proactively allocate additional memory resources to the application to ensure optimal performance. Furthermore, the set of machine learning models 250 may determine that a current state is operating within acceptable performance tolerances during a period and use this period to adjust one or more configuration parameters.

The orchestration system 260 may perform Autonomous Continuous Monitoring (ACM) to continuously monitor the usage of resources such as CPU, memory, storage, and bandwidth across the infrastructure. The orchestration system 260 may identify underutilized, overutilized, or stressed resources in real time. By doing so, it ensures that the system remains efficient and responsive to changing demands. The orchestration system 260 may provision or modify cloud infrastructure via external services and operates as a centralized interface that manages and automates the deployment of cloud resources. The orchestration system 260 may allow external systems or applications to trigger provisioning or configuration changes. For example, the orchestration system 260 may, in response to an external system or application, call one or more predefined, centrally managed templates. These resource templates are standardized blueprints containing the appropriate configurations for each resource type, such as virtual machines, databases, or networking components that are tailored to specific environments, such as availability zones or tiers (i.e., development, testing, or production).

When an external service submits a request, the orchestration system 260 may authenticate the request, validates the request against governance policies (e.g. by using the rules engine 255), and selects the corresponding template based on the requested resource type and environment (e.g., by using one or more outputs of the set of machine learning models 250). Once the appropriate template is selected, the orchestration system 260 may initiate the provisioning process, creating or updating resources in the cloud environment with the exact configurations specified in the template.

The orchestration system 260 may use the set of machine learning models 250 or other components to forecast future capacity needs based on historical data, usage trends, and external factors (such as seasonal changes or expected growth). This would enable proactive adjustments before any capacity limits are reached, avoiding potential bottlenecks. For example, some embodiments may accommodate a predicted capacity limit or underused resources, the orchestration system 260 may adjust allocations, spin up new resources, or decommission idle ones. Additionally, if resource bottlenecks or overprovisioning are detected, the orchestration system 260 may autonomously balance workloads, reroute traffic, or optimize resource allocations to maintain application performance.

In some embodiments, the orchestration system 260 may perform adjustments associated with correcting for underloading a system. For example, some embodiments may adjust scaling parameters by updating auto-scaling policies to reduce the number of virtual instances or cores allocated to the workload. Additionally, some embodiments may select smaller instance types or use fewer resources to match the workload demand. Furthermore, some embodiments may review scheduled scaling and adjust the timing of resource scaling to better align with demand (e.g., based on predicted demand provided by a machine learning model).

In some embodiments, the orchestration system 260 may perform adjustments associated with correcting for overloading a system. The orchestration system 260 may increase the size of the instance or add more CPU cores, memory, or GPU resources for vertical scaling. Additionally, the orchestration system 260 may add more instances (scale out) or containers to distribute the load across multiple nodes for horizontal scaling (e.g., by generating new instances). Furthermore, some embodiments may redistribute workloads across underutilized instances or regions to prevent bottlenecks. Additionally, some embodiments may configure auto-scaling policies to automatically add or remove resources based on utilization metric. For example, some embodiments may add more instances when CPU usage exceeds 60%.

In some embodiments, the orchestration system 260 may modify a schedule by modifying parameters of a scheduling policy, resource allocation rules, priority settings, or other parameters by a scheduling algorithm or scheduler component. For example, some embodiments may use a machine learning model to determine parameter values for pod scheduling policies, node affinity rules, etc. Some embodiments may then modify a schedule by modifying one or more configuration parameters of a scheduler component based on these parameter values. Furthermore, some embodiments may use dynamic scaling policies that automatically trigger based on real-time performance metrics. For example, some embodiments may implement auto-scaling rules that trigger additional instances when CPU utilization remains above 60% for five consecutive minutes or reduce the number of instances when utilization falls below 30%.

In some embodiments, the orchestration system 260 may establish a baseline for system performance and cost by measuring critical metrics like CPU utilization, memory usage, disk I/O, network traffic, and response times under current infrastructure conditions. Baseline data helps understand how the system is performing before any changes are made, serving as a reference point for future adjustments. For example, a cloud-based application may run on several medium-sized virtual instances, with CPU utilization averaging 30%, memory usage at 50%, and response times well within acceptable limits.

Some embodiments may define infrastructure policy parameters, such parameters causing a reduction cloud resource utilization by a certain percentage, maintaining a target response time under specific load conditions, or increasing the likelihood that CPU or memory utilization is within a tolerance boundary (e.g., within a 40-60% tolerance boundary). Additionally, some embodiments may reduce an instance size of an application instance or otherwise lower a CPU or memory capacity for a distributed application (e.g., reduce by 10% or some other percentage) to test if the distributed application can still perform efficiently with fewer available resources. If so, some embodiments may modify a schedule for the distributed application.

In some embodiments, the orchestration system 260 may make changes to infrastructure operations by modifying one or more parameters. Some embodiments may increase or decrease the size of compute instances for vertical scaling, adjust the number of instances or containers to handle load distribution for horizontal scaling, or try different types of virtual machines for resource type tuning. For example, after performing such adjustments, a monitoring subsystem may show that CPU utilization has increased to 60%, memory usage has spiked to 85%, and response times have degraded.

In some embodiments, the orchestration system 260 may track one or more metrics after performing an adjustment. Some embodiments may track CPU, memory, and disk I/O utilization as utilization metrics, measure how quickly the system responds to user requests or processes workloads as response times, observe error logs or system failures that might arise due to resource constraints as error rates, and calculate the impact of resource changes on cloud costs, comparing against the baseline as cost metrics. For example, some embodiments may determine that the CPU was underutilized before a timepoint, but that memory is now a bottleneck based on tracked metrics obtained after the timepoint. Furthermore, some embodiments may revert a configuration setting to an original instance size for memory but retain a smaller CPU configuration.

In some embodiments, the orchestration system 260 may determine whether a distributed system determines reward values or punishment values based on the performance or cost objectives indicated by an application state or infrastructure state. If the adjustment caused enhanced performance or lower resource utilization (while still permitting an application to be performant), some embodiments may continue with similar optimizations or update a schedule to recreate the adjustment based on appropriate conditions. Conversely, if the change degrades performance or increases costs without sufficient benefits, some embodiments may revert the change or test a different configuration.

### Flowchart

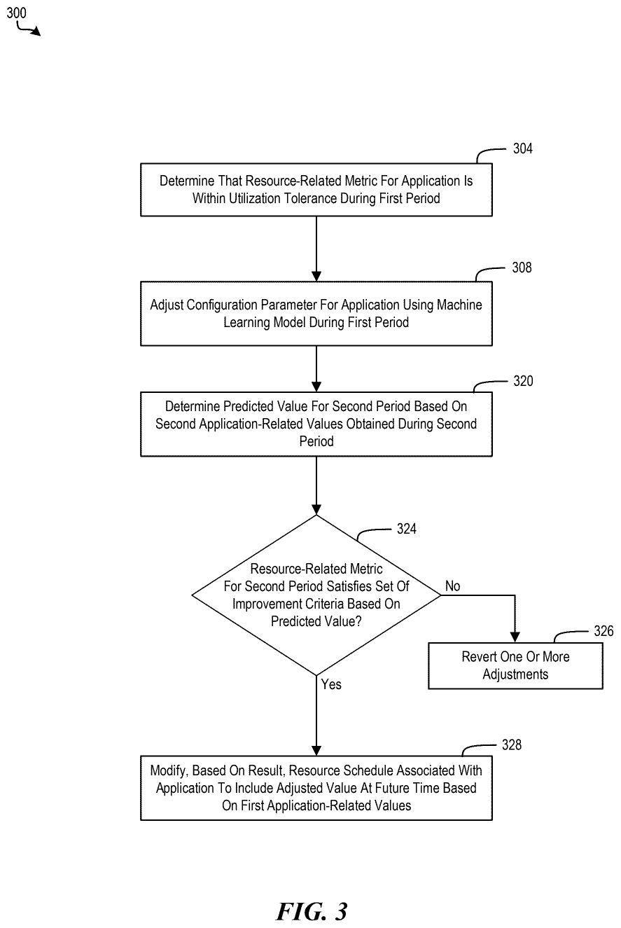

FIG. 3 shows a flowchart of a process 300 for training and using a machine learning model to manage network infrastructure for an application based on predicted results, in accordance with one or more embodiments.

Some embodiments may determine that a resource-related metric for an application is within a utilization tolerance during a first period, as described in block 304. Some embodiments may determine that a memory usage metric or other type of resource-related metric for a deployed application hosted on a node is less than a maximum utilization threshold or other type of utilization tolerance during an adjustment period. For example, some embodiments may determine that a memory usage for an application remains below 80% during peak hours, where 80% may be an upper tolerance boundary for memory usage. Furthermore, other types of utilization tolerances may be used, such as general processor utilization, specific types of processor utilization (e.g., utilization of all graphics processor units), storage utilization, network latency, network bandwidth utilization, etc.

Some embodiments may use utilization tolerances that indicate that, in a cloud computing system, an application or a system hosting the application is running within a range sufficient for optimal performance or baseline performance. For example, some embodiments may monitor metrics for a web application running on a cloud server with 16 GB of RAM. Some embodiments may obtain data indicating that the application is consistently using between 40-60% of resources and determine that memory utilization is within an acceptable tolerance because this value is less than 60%.

Various types of resources may be measured. Resources may include virtual machines, containers, serverless functions, and bare metal servers, network and network components used to connect these devices, etc. Resource-related metrics may include processor-related metrics, such as CPU utilization, processing speed, core count, and thread performance. Resources may also include storage resources, such as block storage, object storage, file systems, and database storage. Resource-related metrics regarding such resources may include storage-related metrics such as read/write speeds, storage capacity, IOPS (input/output operations per second), latency, and data transfer rates. Resources may also include networking resources such as load balancers, virtual private networks, subnets, bandwidth allocation, and network interfaces. Resource-related metrics regarding such resources may include network throughput, packet loss, latency, connection count, and data transmission volumes. Resources may also include memory resources such as random-access memory (RAM) or specific types of memory. Resource-related metrics regarding such resources may include total memory capacity, active memory usage, memory allocation rates, cache hit rates, and memory swap frequencies. Furthermore, some embodiments may also track or derive broader system-level metrics, such as overall resource utilization percentage, cost efficiency, scalability potential, and performance bottlenecks. Additionally, some embodiments may use a classification machine learning model or other diagnostic model to output one or more categories indicative of a system status. Additionally, some embodiments may measure performance resources with other measurements, such as a disk queue amount (e.g., a disk queue percentage) being consumed, a packet loss (e.g., packet loss percentage), and other metrics adjacent to such types of measurements.

Some embodiments may adjust a configuration parameter for the application using a machine learning model during the first period, as described in block 308. Some embodiments may adjust, during the first period, a configuration parameter for the application to an adjusted value with a machine learning model based on first application-related values obtained during the first period. For example, some embodiments may decrease a specific type of memory allocated to an application (e.g., heap memory, stack memory, virtual memory, etc.). Some embodiments may perform adjustments to configuration parameters controlling the allocation or utilization of memory or other resources during an adjustment period characterized by one or more parameters acting within an acceptable tolerance. By performing such adjustments within a period of system state performing within an accepted tolerance, some embodiments may safely experiment with configuration parameters under real-world conditions.

In some embodiments, the adjustment may include switching to a new resource type (e.g., a memory-optimized container or virtual machine). For example, an application may initially be executing on a lesser-memory workload unit. Some embodiments may then adjust a configuration parameter that causes the application to execute on a greater-memory workload unit. Alternatively, some embodiments may adjust a configuration parameter that causes an application executing on a greater-memory workload unit to instead be executing on a lesser-memory workload unit. By modifying a resource type, some embodiments may provide more efficient system-wide resource allocation for applications that require them while maintaining performant operations for less resource-intensive applications.

Some embodiments may adjust the configuration parameters based on the output of a machine learning model, such as a reinforcement learning model. Various types of reinforcement learning models may be used, such as a Q-learning network model, a policy gradient model that may adjust action probabilities based on whether an outcome is considered reward or punishment, etc. The reward and failure states used to train the reinforcement learning model may be based on whether one or more metrics satisfy a corresponding metric threshold or a cost function indicating a difference between a metric and a target value. For example, some embodiments may determine that a reward state is achieved when a memory utilization metric remains below 80% during peak hours or that a failure state is achieved when memory utilization exceeds 90%. During or after training, the reinforcement learning model may adjust the configuration parameter from a first value to a second value. For example, some embodiments may adjust the memory allocation configuration parameter from a first value of 4 GB to a second value of 6 GB based on the output of a reinforcement learning model trained to predict optimal future memory allocations.

When considering inputs for a machine learning model used to determine an adjustment or a predicted value, various metrics or other types of data may be used. For example, some embodiments may consider system error messages or other indications an anomaly. As another example, some embodiments may obtain an indication of one or more error messages generated by infrastructure operations. Some embodiments may then detect whether this error message was generated by a candidate error message, where this candidate error message type does not match any error message types generated during or before the first period. For example, some embodiments may receive an error message stating “00:01 ContainerCannotRun.” Some embodiments may determine that this is a “ContainerCannotRun” error and that this error is not conventionally experienced based on a permitted list of error types. Error types may include errors that indicate that a Kubernetes pod has failed to start, errors indicating issues pulling container images, errors indicating that nodes can't schedule pods, errors indicating cluster node failures, errors indicating container runtime errors, errors indicating problems related to cluster networking, etc.

In some embodiments, a predicted value may include a predicted network metric, such as a response time measurement. For example, some embodiments may predict a response time using one or more prediction models described in this disclosure and determine a response time threshold based on the predicted response time. Some embodiments may then adjust one or more configuration parameters and obtain a response time measurement (e.g., a round-trip time, a ping measurement, a etc.) that is less than or equal to the response time threshold. For example, some embodiments may provide historical data on server load, network latency, and user activity to a prediction model that then forecasts that a response time will be around 200 milliseconds in one hour and then set 180 milliseconds as a response time threshold. Some embodiments may make an adjustment and determine that, during an evaluation period, the mean average response time is 170 milliseconds. Some embodiments may then establish that the state of an infrastructure is a reward state for future training operations based on the mean average response time being less than the response time threshold.

As described elsewhere in this disclosure, a machine learning model may be used to control the schedule used to control infrastructure components. A schedule may include a framework for task allocation and execution in a distributed computing system that coordinates computational work across multiple interconnected nodes. The schedule may be stored in various forms, such as a construct in an adaptive in-memory data structure. The schedule may assign tasks based on processing capacity, current load, and computational requirements while managing load balancing and synchronization. The schedule may configure operations to occur in parallel by distributing workloads, handling potential failures through task replication and reassignment, and adapting to changing system resources and network conditions.

Various types of adjustments may be made, where the manner of adjustment may depend on the type of computing system being modified. For example, some embodiments may modify a virtual machine configuration to control the state of a set of virtual machines hosting a web application. Some embodiments may control the amount of memory allocated to the web application during the virtual machine's initialization. Virtual machine configuration parameters may include CPU cores, memory allocation, disk storage type and size, network interface settings, virtualization technology, hypervisor type, security groups, snapshot capabilities, or other performance optimization parameters. As another example, in some embodiments, an application may be hosted in a set of containers. Some embodiments may then modify a container orchestration value for the set of containers. For example, some embodiments may control a number of replicas for the container. Container orchestration values may include values such as a node placement value, affinity/anti-affinity for scheduling relationships, resource limits for computing constraints, priority classes for scheduling precedence, replica count for pod instances, and update strategy for container rollout.

Some embodiments may determine a predicted value for a second period based on second application-related values obtained during the second period, as described in block 320. For example, some embodiments may provide, to a performance prediction model, data on current memory consumption, current CPU usage, number of users that are concurrently using the application, throughput metrics indicating a quantity of database transactions, etc. The performance prediction model may then predict a memory utilization for the deployed application during an evaluation period. Some embodiments may generate the prediction before the evaluation period takes place, where the inputs to the prediction model are obtained before the evaluation period starts. For example, some embodiments might collect data on memory consumption, CPU usage, and user activity for a deployed application before Jun. 1, 20XX and provide this data to a prediction model that outputs a predicted memory utilization value for the deployed application during an upcoming evaluation period that starts on Jun. 1, 20XX. Alternatively, or additionally, some embodiments may generate the prediction during the evaluation period itself, where inputs to the prediction model may be obtained during the evaluation period starts. For example, some embodiments might collect data on memory consumption, GPU usage, and concurrent users for a deployed application on Jun. 1, 20XX and provide this data to a prediction model that outputs a predicted memory utilization value for the deployed application on the same day, Jun. 1, 20XX.

Some embodiments may determine result indicating that the resource-related metric for the second period satisfies a set of improvement criteria based on the predicted value, as described in block 324. For example, some embodiments might predict that the memory utilization for an application will be 75% during the second period. Some embodiments may then set 75% as a maximum utilization threshold to which to compare a measured processor utilization value. If the actual memory utilization during the second period is 70%, the system may determine that the resource-related metric satisfies the threshold. The result may be based on one type or more types of various types of changes, including software changes or infrastructure changes, where the result may be associated with specific deviations in performance. For example, some embodiments may determine that a first resource-related metric measured on Jul. 1, 20XX indicates a negative impact on memory performance as a result of an infrastructure change to an autoscaling policy on Jun. 1, 20XX. As another example, some embodiments may determine, based on a second resource-related metric measured on Dec. 1, 20XX, indicating that a software change (e.g., update to an application to introduce a new feature in a machine learning model) distributed on Aug. 1, 20XX had a positive impact on network performance.

Some embodiments may require a minimum degree of improvement before an adjustment is considered an improvement. For example, some embodiments may predict that memory utilization will decrease to 20% without an adjustment due to future user activity. Some embodiments may then apply a 2% improvement requirement such that the threshold for memory utilization is that memory utilization will decrease by at least 22%. Some embodiments may then perform the adjustment and measure the memory utilization to determine that, during an evaluation period, the memory utilization must meet or exceed this threshold for the adjustment to be considered successful.

Various types of thresholds or other criteria may be used to determine whether a satisfactory improvement. For example, some embodiments may determine a set of improvement criteria that includes a maximum utilization threshold, such as a maximum processor utilization threshold or a maximum memory utilization threshold. Implementing a maximum processor utilization threshold may train a model to reduce the risk of a CPU usage that exceeds a certain limit during peak operations by establishing such a state as a punishment state. Similarly, implementing a maximum memory utilization threshold may train a model to reduce the risk of a memory usage that exceeds a certain limit during peak operations by establishing such a state as a punishment state.

Some embodiments may implement an adaptive threshold that is independent of predicted values. Some embodiments may define acceptable performance thresholds for critical metrics, such as CPU utilization, memory usage, disk I/O, network bandwidth, and GPU utilization (if applicable). For each metric, some embodiments may determine the upper and lower bounds defining when the system is overloaded or underloaded. For example, some embodiments may set underload thresholds, such as CPU utilization consistently below 30% or memory usage less than 40%, indicating underutilization. Conversely, some embodiments may establish overload thresholds, such as CPU utilization exceeding 60% over a prolonged period or memory usage surpassing 80%, indicating an overloaded system.

In some embodiments, a reward or punishment state may be based on a state that occurs over a duration. For example, some embodiments may establish a set of improvement criteria that includes a criterion that memory usage does not exceed a permissible violation duration threshold. The permissible violation duration threshold may be set to one of various periods, such as a period less than one second, a period less than one minute, a period less than one hour, a period less than one day, a period less than one week, etc.

Some embodiments may set a successful adjustment as a reward state that may then be used to further train a reinforcement learning model. For example, some embodiments may first adjust a configuration parameter of a cloud infrastructure to change the parameter from a first value to a second value. Then, based on a difference between a measured resource usage metric (e.g., a memory usage metric) and a predicted utilization value (e.g., a predicted memory utilization metric), some embodiments may determine that an infrastructure state is a reward state if the difference exceeds a threshold (e.g., 10% less predicted memory value, 15% less than a predicted network latency, etc.). In response to a reward state, some embodiments may update a reward value associated with an adjustment value. Additionally, some embodiments may define a reward state as one that is not a punishment state.

It should be understood that some embodiments may modify a configuration parameter that directly controls one type of resource but base a reward or failure state based on metrics related to another type of resource. For example, some embodiments may modify an orchestration policy parameter that controls an amount of memory resources available to an application. Some embodiments may then determine whether a state during an evaluation period is a reward or failure state based on a processor utilization value (e.g., comparing a processor utilization with a predicted processor utilization). Similarly, some embodiments may modify a configuration parameter for an amount of processor resources (e.g., number of general processors allocated, number GPUs allocated, etc.) available to the application and then determine a reward state or failure state based on a memory utilization value.

Some embodiments may modify a resource schedule by updating a policy of the reinforcement learning model to increase a reward value associated with the second value or the difference between the second value and the first value. For example, if the reinforcement learning model determines that increasing memory allocation during peak hours improves application performance, the system may update the policy to increase the reward value for this adjustment, thereby encouraging similar adjustments in the future.

In response to a determination that the resource-related metric for the second period satisfies the set of improvement criteria based on the predicted value, some operations of the process 300 may proceed to operations described for block 328. Otherwise, operations may proceed to operations described for block 326.

Some embodiments may revert one or more adjustments, as described by block 326. Some embodiments may revert an adjustment if the improvement detected for that adjustment is insufficient. For example, some embodiments may adjust a processor allocation parameter to a greater value. After adjustment, some embodiments may compare a measured response time with a minimum response time threshold derived from a predicted performance metric (e.g., 5% less than the predicted performance metric). Some embodiments may then determine that the measured response time is greater than the minimum response time threshold and, in response, revert the processor allocation to its original value. Such reversions may help maintain system resources, which may be especially important in cases where system resources may be shared with other applications. Alternatively, some embodiments may skip such reversions, especially if an adjustment shows no improvement in application performance but allows an application to become less resource intensive.

Some embodiments may, based on the result, modify a resource schedule associated with the application to comprise the adjusted value at a future time based on the first application-related values, as described in block 328. For instance, some embodiments may determine that increasing memory allocation during peak hours improves application performance based on one or more thresholds being satisfied and, in response, update a configuration policy schedule to perform this adjustment to occur automatically during future peak periods.

The above-described embodiments of the present disclosure are presented for purposes of illustration and not of limitation, and the present disclosure is limited only by the claims which follow. Furthermore, it should be noted that the features and limitations described in any embodiment may be applied to one or more other embodiments herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Furthermore, not all operations of a flowchart need to be performed. In addition, the systems and methods described herein may be performed in real time. It should also be noted that the systems and/or methods described above may be applied to, or used in accordance with, other systems and/or methods.

Furthermore, the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. For example, while the client device 102 of FIG. 1 may be a laptop device, another type of mobile computing device may be possible. Furthermore, the embodiments described in this disclosure may include an individual device that performs some or all the operations described in this disclosure. Alternatively, other embodiments may include multiple computing devices acting collectively to perform some or all the operations described in this disclosure.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on one or more non-transitory, machine-readable media (e.g., a set of machine-readable storage media), such as an electronic storage medium. Furthermore, the use of the term “media” may include a single medium or combination of multiple media, such as a first medium and a second medium. One or more non-transitory machine-readable media storing instructions may include instructions included on a single medium or instructions distributed across multiple media. For example, non-transitory media may act as one or more memory, where one or more memory may store program instructions that are written as source files or written in machine-executable program code. The processing devices may include one or more devices configured through hardware, firmware, and/or software to be specifically designed for the execution of one or more of the operations of the methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include one or more relational databases. Alternatively, or additionally, the set of databases or other electronic storage used in this disclosure may include one or more non-relational databases.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communication networks or combination of communication networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storage may include one or more non-transitory machine-readable media (e.g., storage media) that electronically stored information. The storage media of the electronic storages may include one or both of (i) system storage that is provided integrally (e.g., substantially non-removable) with servers or client computing devices, or (ii) removable storage that is removably connectable to the servers or client computing devices via port (e.g., a USB port, a firewire port, etc.) or drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The set of electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

Some embodiments may perform one or more operations described in this disclosure using an Application-Specific Integrated Circuit (ASIC). An ASIC is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model's computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC's capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints. Some embodiments may use a custom ASIC to execute a machine learning model used control the distribution of computational resources. For example, a computer system may include or use a specialized ASIC possessing dedicated circuits for parsing, filtering, and analyzing log data (e.g., in the form of regular expression matching engines, hardware-based tokenizers, or specialized comparison units). The computer system may then use the dedicated circuits of this specialized ASIC to train or execute a machine learning model used to infer real-time or batch features applied to incoming log data.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some, or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than a mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record. Additionally, as used in the specification, “a portion” refers to a part of, or the entirety of (i.e., the entire portion), a given item (e.g., data) unless the context clearly dictates otherwise.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” the first item of a set of items may be “item 2” unless otherwise stated.

### Enumerated Embodiments

The present techniques will be better understood with reference to the following enumerated clauses:
1. A method comprising adjusting a configuration parameter for the application to an adjusted value with a machine learning model based on first application-related values.
2. A method comprising: adjusting, during the first period, a configuration parameter for the application to an adjusted value with a machine learning model based on first application-related values obtained during the first period; and determining whether the resource-related metric for the second period satisfies a set of criteria based on the predicted value.
3. A method comprising: adjusting, during the first period, a configuration parameter for the application to an adjusted value with a machine learning model based on first application-related values obtained during the first period; determining a result indicating whether the resource-related metric for the second period satisfies a set of criteria based on the predicted value; and updating the machine learning model based on the result.
4. A method comprising: adjusting, during the first period, a configuration parameter for the application to an adjusted value with a machine learning model based on first application-related values obtained during the first period; determining a predicted value for a second period based on second application-related values obtained during the second period; determining a result indicating that the resource-related metric for the second period satisfies a set of improvement criteria based on the predicted value; and modifying a resource schedule associated with the application to comprise the adjusted value at a future time based on the first application-related values.
5. A method comprising: determining that a resource-related metric for an application is within a utilization tolerance during a first period; adjusting, during the first period, a configuration parameter for the application to an adjusted value with a machine learning model based on first application-related values obtained during the first period; determining a predicted value for a second period based on second application-related values obtained during the second period; determining a result indicating that the resource-related metric for the second period satisfies a set of improvement criteria based on the predicted value; and based on the result, modifying a resource schedule associated with the application to comprise the adjusted value at a future time based on the first application-related values.
6. A method comprising: determining a result indicating that that a memory usage metric for a deployed application hosted on a node is less than a maximum utilization threshold during an adjustment period; based on the result, adjusting, during the adjustment period, a memory configuration parameter to allocate additional resources to the deployed application to an adjusted value by providing a reinforcement learning model with state variables indicating first application runtime telemetry values during the adjustment period; determining that the memory usage metric during an evaluation period has improved by an improvement threshold by: (i) determining a predicted memory utilization value associated with the deployed application for the evaluation period based on second application runtime telemetry values obtained during the evaluation period and (ii) determining the improvement threshold based on the predicted memory utilization value during the evaluation period; and in response to determining that the memory usage metric during the evaluation period has improved by the improvement threshold, modifying a resource scaling schedule associated with the deployed application to use the adjusted value at a future time based on the first application runtime telemetry values.
7. A method comprising: determining that a resource usage metric for an application is within a utilization tolerance during a first period; adjusting, during the first period, a configuration parameter for the application to an adjusted value with a machine learning model based on first application runtime telemetry values obtained during the first period; determining a predicted utilization value for a second period based on second application runtime telemetry values obtained during the second period; determining a result indicating that the resource usage metric for the second period satisfies a set of improvement criteria based on the predicted utilization value; and based on the result, modifying a resource schedule associated with the application to comprise the adjusted value at a future time based on the first application runtime telemetry values.
8. The method of any of the embodiments above, wherein: the machine learning model comprises a reinforcement learning model; adjusting the configuration parameter comprises adjusting the configuration parameter from a first value to a second value; and modifying the resource schedule comprises updating a policy of the reinforcement learning model to increase a reward value associated with the second value or a difference between the second value and the first value.
9. The method of any of the embodiments above, wherein the resource usage metric is a metric related to processor utilization, and wherein the configuration parameter controls an amount of memory available to the application.
10. The method of any of the embodiments above, wherein the application is being hosted in a virtual machine, and wherein the configuration parameter controls a virtual machine configuration for the virtual machine.
11. The method of any of the embodiments above, wherein the application is being hosted in a container, wherein the configuration parameter controls a container orchestration value for the container.
12. The method of any of the embodiments above, wherein the set of improvement criteria comprises at least one of a maximum processor utilization threshold or a maximum memory utilization threshold.
13. The method of any of the embodiments above, wherein the set of improvement criteria comprises not exceeding a maximum memory utilization threshold for a permissible violation duration threshold.
14. The method of any of the embodiments above, wherein the result is a first result, and wherein determining the first result comprises: determining a second result indicating that an error message of a candidate error message type was generated, wherein the candidate error message type does not match error message types of any error messages generated during or before the first period; and determining the first result based on the second result.
15. The method of any of the embodiments above, wherein the application is executing on a lesser-memory workload unit before the adjusting of the configuration parameter, and wherein adjusting the configuration parameter comprises executing the application on a greater-memory workload unit.
16. The method of any of the embodiments above, wherein adjusting the configuration parameter comprises initializing a new instance of the application based on the configuration parameter.
17. The method of any of the embodiments above, wherein: the resource-related metric comprises a response time measurement; the predicted value comprises a response time threshold; and determining the result comprises determining that the response time measurement is less than or equal to the response time threshold.
18. The method of any of the embodiments above, wherein the adjusted value is a first adjusted value, further comprising: adjusting, during a third period, the configuration parameter to a second adjusted value; determining a second predicted value for a fourth period based on third application-related values obtained during the fourth period; determining a second result indicating that the resource-related metric for the fourth period does not satisfy the set of improvement criteria; and adjusting, during a fifth period, the configuration parameter to the first adjusted value.
19. A tangible, non-transitory, machine-readable medium storing instructions that, when executed by a data processing apparatus, cause the data processing apparatus to perform operations comprising those of any of embodiments 1-18.
20. A system comprising one or more processors; and memory storing instructions that, when executed by the processors, cause the processors to effectuate operations comprising those of any of embodiments 1-18.
21. A system comprising means for performing any of embodiments 1-18.

What is claimed is:

1. A system for managing real network infrastructure for a dynamically scaling application based on a prediction-compared result of adjusting resource availability, comprising:
one or more processors; and
one or more memory storing program instructions that, when executed by the one or more processors, causes operations comprising:
determining a result indicating that that a memory usage metric for a deployed application hosted on a node is less than a maximum utilization threshold during an adjustment period;
based on the result, adjusting, during the adjustment period, a memory configuration parameter to allocate additional resources to the deployed application to an adjusted value by providing a reinforcement learning model with state variables indicating first application runtime telemetry values during the adjustment period;
determining that the memory usage metric during an evaluation period has improved by an improvement threshold by: (i) determining a predicted memory utilization value associated with the deployed application for the evaluation period based on second application runtime telemetry values obtained during the evaluation period and (ii) determining the improvement threshold based on the predicted memory utilization value during the evaluation period; and
in response to determining that the memory usage metric during the evaluation period has improved by the improvement threshold, modifying a resource scaling schedule associated with the deployed application to use the adjusted value at a future time based on the first application runtime telemetry values.

2. A method for managing real network infrastructure, comprising:
determining that a resource usage metric for an application is within a utilization tolerance during a first period;
adjusting, during the first period, a configuration parameter for the application to an adjusted value with a machine learning model based on first application runtime telemetry values obtained during the first period;
determining a predicted utilization value for a second period based on second application runtime telemetry values obtained during the second period;
determining a result indicating that the resource usage metric for the second period satisfies a set of improvement criteria based on the predicted utilization value; and
based on the result, modifying a resource schedule associated with the application to comprise the adjusted value at a future time based on the first application runtime telemetry values.

3. The method of claim 2, wherein:
the machine learning model comprises a reinforcement learning model;
adjusting the configuration parameter comprises adjusting the configuration parameter from a first value to a second value; and
modifying the resource schedule comprises updating a policy of the reinforcement learning model to increase a reward value associated with the second value or a difference between the second value and the first value.

4. The method of claim 2, wherein the resource usage metric is a metric related to processor utilization, and wherein the configuration parameter controls an amount of memory available to the application.

5. The method of claim 2, wherein the application is being hosted in a virtual machine, and wherein the configuration parameter controls a virtual machine configuration for the virtual machine.

6. The method of claim 2, wherein the application is being hosted in a container, wherein the configuration parameter controls a container orchestration value for the container.

7. The method of claim 2, wherein the set of improvement criteria comprises at least one of a maximum processor utilization threshold or a maximum memory utilization threshold.

8. The method of claim 2, wherein the set of improvement criteria comprises not exceeding a maximum memory utilization threshold for a permissible violation duration threshold.

9. The method of claim 2, wherein the result is a first result, and wherein determining the first result comprises:
determining a second result indicating that an error message of a candidate error message type was generated, wherein the candidate error message type does not match error message types of any error messages generated during or before the first period; and
determining the first result based on the second result.

10. The method of claim 2, wherein the application is executing on a lesser-memory workload unit before the adjusting of the configuration parameter, and wherein adjusting the configuration parameter comprises executing the application on a greater-memory workload unit.

11. The method of claim 2, wherein adjusting the configuration parameter comprises initializing a new instance of the application based on the configuration parameter.

12. One or more non-transitory machine-readable media storing program instructions that, when executed by one or more processors, performs operations comprising:
determining that a resource-related metric for an application is within a utilization tolerance during a first period;
adjusting, during the first period, a configuration parameter for the application to an adjusted value with a machine learning model based on first application-related values obtained during the first period;
determining a predicted value for a second period based on second application-related values obtained during the second period;
determining a result indicating that the resource-related metric for the second period satisfies a set of improvement criteria based on the predicted value; and
based on the result, modifying a resource schedule associated with the application to comprise the adjusted value at a future time based on the first application-related values.

13. The one or more non-transitory machine-readable media of claim 12, wherein:
the resource-related metric comprises a response time measurement;
the predicted value comprises a response time threshold; and
determining the result comprises determining that the response time measurement is less than or equal to the response time threshold.

14. The one or more non-transitory machine-readable media of claim 12, wherein the adjusted value is a first adjusted value, the operations further comprising:
adjusting, during a third period, the configuration parameter to a second adjusted value;
determining a second predicted value for a fourth period based on third application-related values obtained during the fourth period;
determining a second result indicating that the resource-related metric for the fourth period does not satisfy the set of improvement criteria; and
adjusting, during a fifth period, the configuration parameter to the first adjusted value.

15. The one or more non-transitory machine-readable media of claim 12, wherein:
the machine learning model comprises a reinforcement learning model;
adjusting the configuration parameter comprises adjusting the configuration parameter from a first value to a second value; and
modifying the resource schedule comprises updating a policy of the reinforcement learning model to increase a reward value associated with the second value or a difference between the second value and the first value.

16. The one or more non-transitory machine-readable media of claim 12, wherein the resource-related metric is a metric related to processor utilization, and wherein the configuration parameter controls an amount of memory available to the application.

17. The one or more non-transitory machine-readable media of claim 12, wherein the application is being hosted in a virtual machine, and wherein the configuration parameter controls a virtual machine configuration for the virtual machine.

18. The one or more non-transitory machine-readable media of claim 12, wherein the application is being hosted in a container, wherein the configuration parameter controls a container orchestration value for the container.

19. The one or more non-transitory machine-readable media of claim 12, wherein the set of improvement criteria comprises at least one of a maximum processor utilization threshold or a maximum memory utilization threshold.

20. The one or more non-transitory machine-readable media of claim 12, wherein the set of improvement criteria comprises not exceeding a maximum memory utilization threshold for a permissible violation duration threshold.
